(19) United States
(12) Patent Application Publication
(10) Pub. No.: US 2024/0112521 A1
(43) Pub. Date: Apr. 4, 2024

(54) ELECTRONIC GAMING SYSTEM EMPLOYING A PLURALITY OF DYNAMIC SIDE DISPLAY PANELS

(71) Applicant: Aristocrat Technologies, Inc. (ATI), Las Vegas, NV (US)

(72) Inventors: Rajendrasinh Jadeja, Las Vegas, NV (US); Xiaoqiang Gong, Henderson (NV)

(21) Appl. No.: 18/369,614

(22) Filed: Sep. 18, 2023

Related U.S. Application Data
(60) Provisional application No. 63/411,238, filed on Sep. 29, 2022.

(51) Int. Cl. G07F 17/32

(52) U.S. Cl. CPC G07F 17/3211; G07F 17/3216

(57) ABSTRACT

Systems, devices, and methods are disclosed for an electronic gaming system employing a plurality of dynamic side display panels arranged vertically adjacent to a main display. In some examples, the dynamic side lighting displays are integrated into a primary and/or secondary cabinet(s) of the gaming machine. The dynamic side lighting displays may be a dynamic, often vertically oriented panel employing a plurality of controllable light emitting diodes (LEDs).

### RELATED APPLICATIONS

The present application claims priority to U.S. Provisional Patent Application No. 63/411,238, filed Sep. 29, 2022, and entitled “ELECTRONIC GAMING SYSTEM EMPLOYING A PLURALITY OF DYNAMIC SIDE DISPLAY PANELS” which is hereby incorporated by reference in its entirety.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens, or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

Systems, devices, and methods are disclosed for an electronic gaming system employing a plurality of dynamic side display panels arranged vertically adjacent to a main display.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram depicting example system arrangements in a casino gaming environment according to some aspects of the present disclosure.

FIG. 2D is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A-4C illustrate an example electronic gaming system employing a plurality of dynamic side lighting display panels arranged vertically adjacent to a main display, in accordance with various implementations described herein.

FIGS. 5A-5H illustrate other example electronic gaming systems employing a plurality of dynamic side lighting display panels arranged vertically adjacent a main display, in accordance with various implementations described herein.

FIG. 6A is an example block diagram of a control architecture for controlling an electronic gaming system employing a plurality of dynamic side lighting display panels arranged vertically adjacent a main display in accordance with various implementations described herein.

FIG. 6B is an example block diagram of a logic cage for an electronic gaming system employing a plurality of dynamic side lighting display panels arranged vertically adjacent to a main display in accordance with various implementations described herein.

FIG. 7 is a flowchart illustrating exemplary steps for operating an electronic gaming system in accordance with various implementations described herein.

### DETAILED DESCRIPTION

Systems, devices, and methods for an electronic gaming system employing one or more dynamic side lighting displays. In some examples, the dynamic side lighting displays are integrated into a primary and/or secondary cabinet(s) of the gaming machine. The dynamic side lighting displays may be a dynamic, often vertically oriented panel employing a plurality of controllable light emitting diodes (LEDs).

As disclosed herein, the dynamic side, or edge, lighting displays are accessory lighting sources to enhance a player's experience. Although some side lighting displays are used for limited purposes, such as a simple color change, in some disclosed examples the side lighting displays enhance the player's experience by providing color changes, but also dazzling, eye-catching graphic animations, text messages, and/or virtual three-dimensional (3D) characters (which may include holographic content), therefore drawing the player into a more immersive experience with an ergonomic and informative environment.

Advantageously, mounting the side lighting displays on the sides of the gaming cabinet in this manner creates an extension of the game canvas through the main display, which provides additional space to convey information or graphics to a user since spacing in gaming environments may be limited. For example, some gaming systems or devices would benefit from being able to display game outcomes or different games in various display windows. Additionally, side lighting displays may be used to provide information or multimedia content to nearby users or to attract the attention of users who are passing by.

Examples provided in the present disclosure represent a technical improvement in the art of electronic gaming machines, devices, systems, and operation of such electronic gaming machines, devices, or systems. Some embodiments of the present disclosure include an improved electronic gaming machine or system to dynamically display multimedia content, such as base and feature games, graphics, video, dynamic text, etc. to a user. Some types of content are associated with a probability for earning rewards and, ultimately, are presented to the player with an opportunity to select from a variety of games or dynamic features.

Gaming systems or devices may allow players to win awards. The awards may be determined based on predefined volatility criteria or return-to-player. Yet technical problems exist involving how a gaming device may satisfy a designated game return-to-player that complies with applicable regulations for certain games or game features, or that achieves a certain game volatility, in particular where the gaming device involves several game instances based on random outcomes with persistent game symbols increasing the numbers of ways to win based on bet sizes. To meet or satisfy a target volatility criterion or designated RTP, the random nature of a game determination may, in some instances, generate numerous game outcomes in the background for various display windows before determining and displaying game outcomes to a player that satisfies the target volatility criterion or designated RTP for the designated jurisdiction. Once the game outcomes are determined, the outcomes must be conveyed to a player. The confined screen size of many electronic gaming devices creates challenges as to how game changes and related information are effectively communicated to the player.

For example, when multiple games or when base games and feature games are implemented simultaneously, increasing the number of games risks potential high probability of earning awards and increased payouts that exceed allowable RTP. These challenges require realization of gaming machine processing configuration to control enhanced play characteristics across each of the base games and/or feature games and across displays due to changing volatility and to achieve a predetermined RTP for the different games.

More specifically, by way of example, exemplary embodiments of the present disclosure improve the technical capability of the electronic gaming machines, devices, and systems. An enhanced technical capability may be accomplished by controlling the processor to control activation and operation of each base game, where a processor is driven to perform a sequence of instructions involving multiple individual base games and different base game states stored in a memory. Game execution can be based on a defined trigger probability associated with each of the base games, including a selectable type of game, and assigned ranges of values returnable in conjunction with a random number generator (RNG) to trigger one or more of the base games, bonus games, and/or dynamic features, for example. In general, embodiments of the present disclosure dynamically configure activation and operation of the base game with game characteristics and game states when each base game is triggered, while still achieving a predetermined volatility and/or a predetermined RTP to comply with jurisdictional regulations, and simultaneously presenting the base game to the player.

Technical challenges exist in determining types and amounts of awards for gameplay with multiple base games. The points, credits, or states achieved in one base game may affect which and/or how a bonus game or dynamic feature game is offered, and particularly, how the volatility associated with selection of awards and amounts is determined. For example, in some embodiments, the improvement in gaming machine capability occurs through operational advantages in, among other things, configuring a triggered feature game by processing dynamically to allow the credits accumulated, counted or monitored to trigger or activate a bonus game or dynamic feature, to determine a number of reel spins to collect the credits required to activate the bonus game or dynamic feature, to change weight tables and/or reels for determining wins and/or awards, and to determine additional payouts or awards dynamically when the bonus game or dynamic feature is achieved and/or selected.

Challenges also occur in steady state base game progressions. Improvements in game machine capability occur with embodiments of the present invention through recognition of the advantages of employing game processing to control the speeds or progression at which base games transition or progress from a given award to a bonus award or dynamic feature, while achieving the desired RTP and game volatility. As such, in some embodiments, the progression or speed may be controlled, for example, such that higher paying variations will offer bonus awards or dynamic features more quickly. In other embodiments, the progression or speed may be controlled by having more opportunities to play the base games (e.g., free play), such that the transition from base gameplay to a bonus award or dynamic feature may take longer. In yet other embodiments, the progression or speed may be controlled, for example, such that higher paying variations will access bonus awards or dynamic features more slowly.

Additionally, an improvement in the display and graphical user interfaces of the game machine is achieved by employing games that may, concurrently or subsequently, function to animate special effects on a display in response to one or more of the games being initiated based on a player selection. Such graphical effects on the display efficiently use the available fixed-size display screen of the gaming machine or device to visually communicate enhanced game play characteristics and outcomes, while still accommodating presentation and appreciation of traditional gaming visual effects, e.g., a base game, and credits, etc. For example, the base game, bonus games, and/or dynamic features are synchronized, coordinated, and presented to the user across various displays based on the characteristics of the game and the characteristic of the displays available to the user. Providing an enhanced display allows the player to rapidly appreciate and understand visually the graphical effects game progress, award differences, and gaming actions to be taken without being overly burdened by complicated visual presentation and mathematical calculations. The enhanced display, in turn, provides improved game interaction and anticipation characteristics for the player and provide more varied game outcomes. Additionally, synchronization of various displays allows the user to be provided with touch input controls at appropriate times to provide feedback or to be able to input information in order to continue play. Thus, embodiments of the present disclosure are not merely new game rules or simply new display patterns, but provide technologic improvements to computer and gaming capabilities and graphical user interfaces in the technical art of electronic gaming machines.

The above example is not intended to be limiting, but merely exemplary of technologic improvements provided by some embodiments of the present disclosure. Technological improvements of other embodiments are readily apparent to those of ordinary skill in the art in light of the present disclosure.

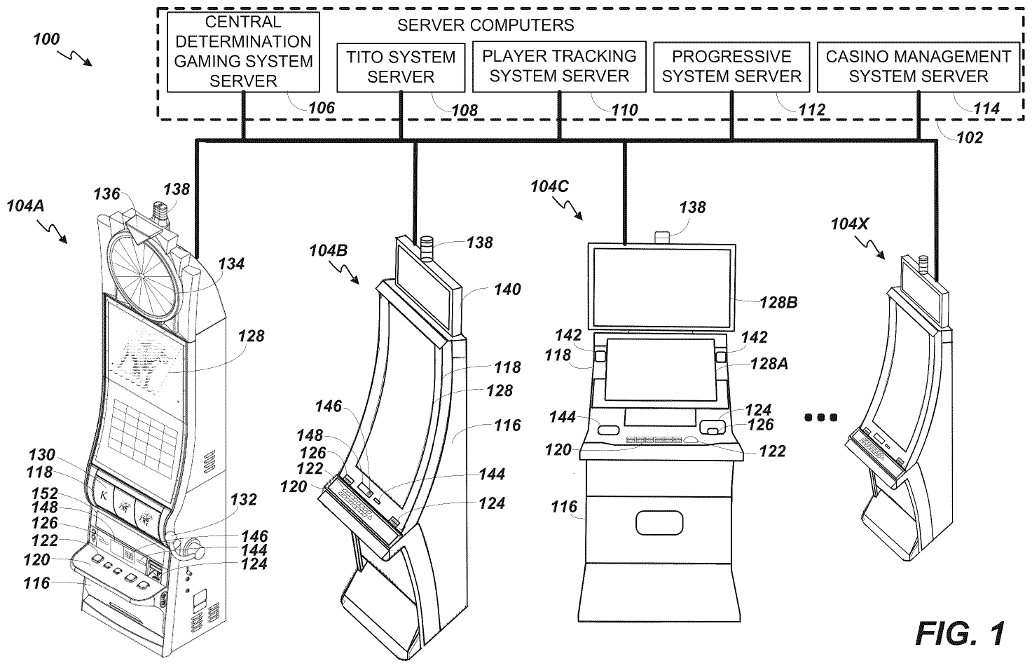

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B, or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat ° Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

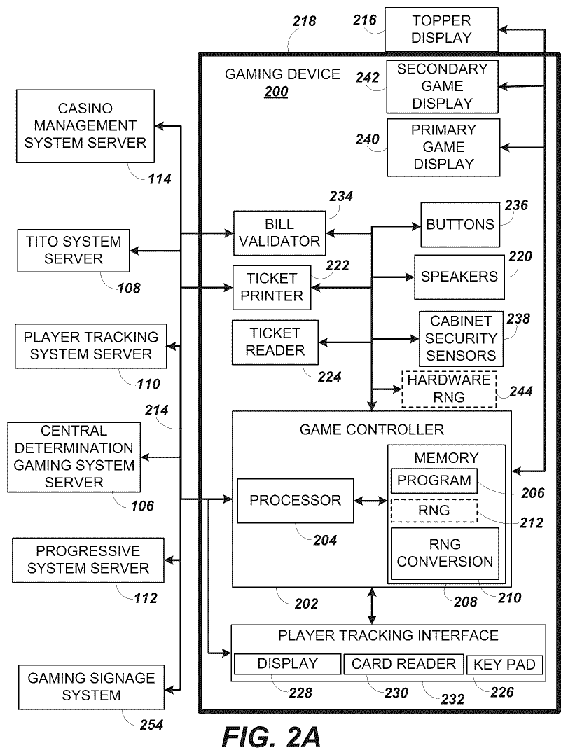

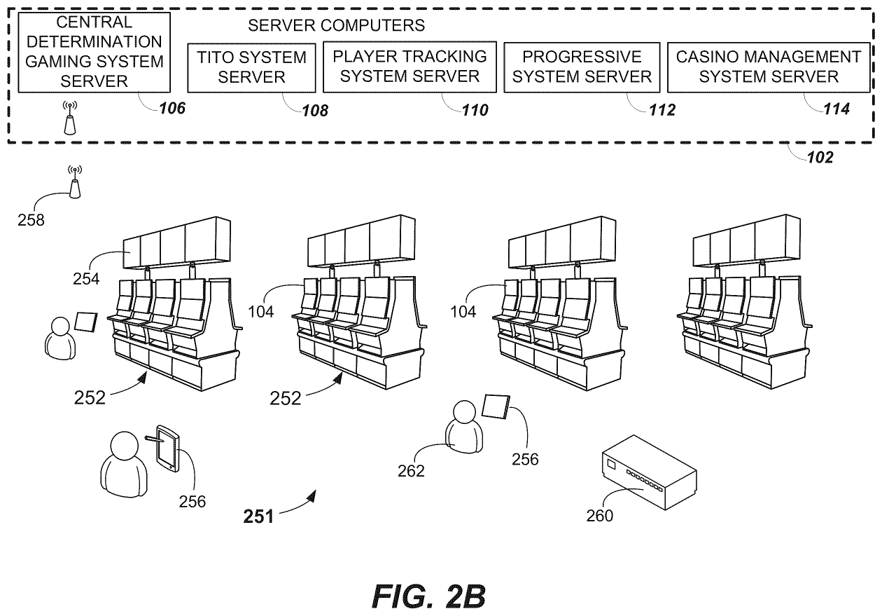

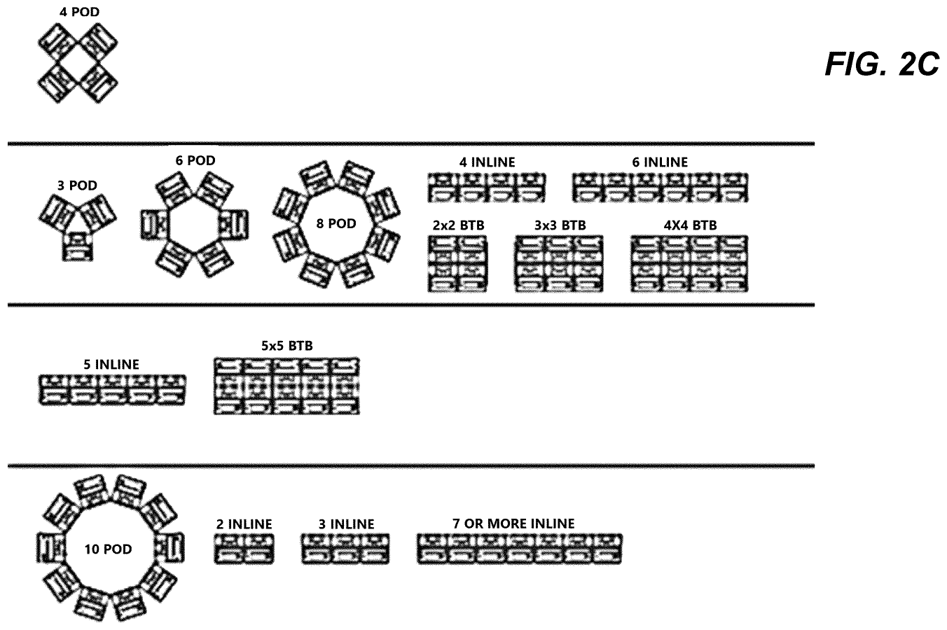

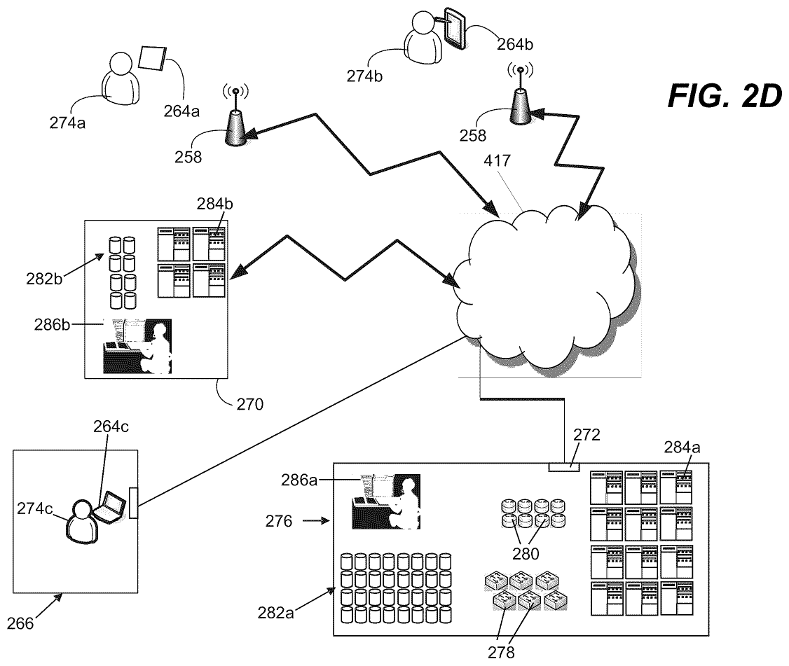

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), and a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS ° system manufactured by Aristocrat ° Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment, and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). Additional example arrangements of the banks 252 of EGMs 104 is provided below with regards to FIG. 2C. According to this implementation, the casino 251 also includes mobile gaming devices 256, which are also configured to present wagering games in this example. The mobile gaming devices 256 may, for example, include tablet devices, cellular phones, smart phones, and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc. In some examples, a player may operate a mobile gaming device to control one or more displays of the EGM 104 (e.g., a display screen, main display, secondary display, side lighting display, etc.). The mobile gaming device (e.g., a phone, tablet, remote controller, etc.) may display one or more games (e.g., windows) of a multi-game display, while the EGM 104 may display other games of the multi-game display. In some examples, the mobile gaming device is operable to display games on one or more displays of the EGM or transfer a game that is currently being played remotely (as described in FIG. 2C below) to an EGM 104.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows example system arrangements in a casino gaming environment according to some aspects of the present disclosure. As with other figures presented in this disclosure, the numbers, types, and arrangements of gaming devices shown in FIG. 2C are merely shown by way of example. The banks 252 of EGMs 104 may be arranged, for example, in a 3, 4, 6, 8, or 10-pod arrangement as depicted in FIG. 2C. The banks 252 may also be provided in an inline arrangement of 2 or more EGMs 104. Another example arrangement may be a Back-to-Back (BTB) arrangement including 2 rows of 2 EGMs (2×2 BTB), 3×3 BTB, 4×4 BTB, etc. as depicted in FIG. 2C.

FIG. 2D is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b, and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a, and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

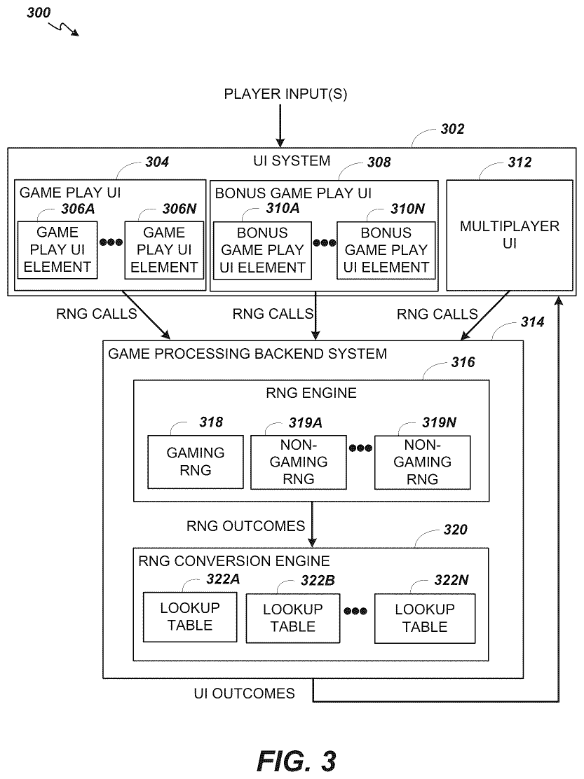

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N.

Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

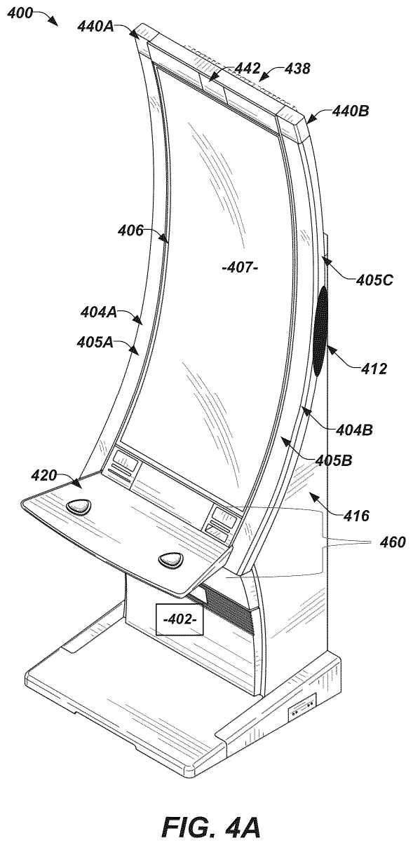

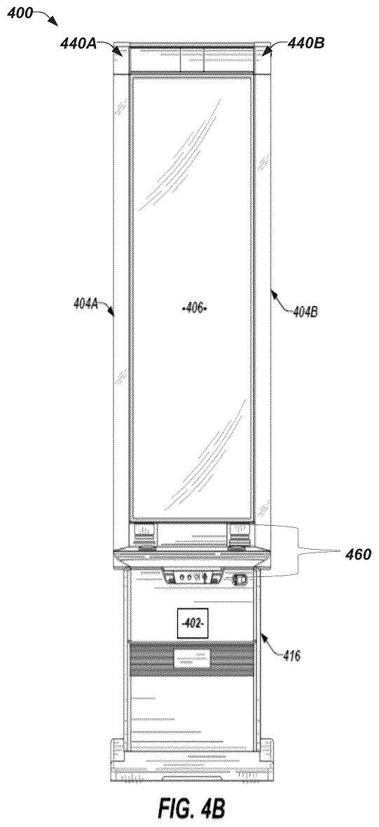

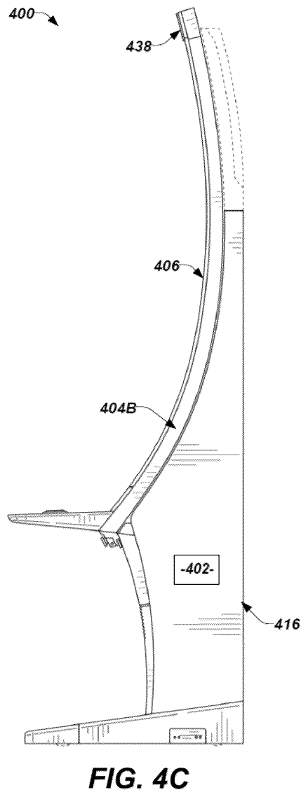

Turning to FIGS. 4A through 4C, a game machine 400 includes one or more side lighting displays, such as left-side lighting display panel 404A and right-side lighting display panel 404B. In some examples, the side lighting display panels 404A, 404B are integrated into the gaming machine cabinet 416 or otherwise coupled to an edge of the gaming machine cabinet 416 and may be flush with the gaming machine cabinet 416. In some examples, the side lighting display panels 404A, 404B cover a front edge of the gaming machine cabinet 416 and extend past the left and right most edges of the gaming machine cabinet 416, thereby framing the sides of a main display 406 (e.g., a 63.5″ curved 4K LCD touch portrait monitor). The left side lighting display panel 404A may include display screens on a front facing side 405A and a left facing side (not shown). The right side lighting display 404B may include display screens on a front facing side 405B and a right facing side 405C.

The main display 406 may be operatively connected to: (i) the gaming machine cabinet 416 as a support for retaining the main display 406 in an upright position and (ii) a top appendage 438 for further supporting the main display 406, such that a bottom edge of the top appendage 438 may be connected to the gaming machine cabinet 416 to prevent tipping. Additionally, the main display 406 may include a display area, such as a display screen 407, having a curvature identical or substantially similar to curvatures of the display screens 405A, 405B, 405C of side lighting display panels 404A, 404B. The display screens 405B, 405C of the side lighting display panel 404B may have the same curvature as the display screens 405A and the left facing side screen (not shown) of the side lighting display panel 404A.

In some examples, the side lighting displays 404A, 404B may display information or content on a same side as the display screen 407 of the main display 406 (e.g., display screens 405A, 405B of the side lighting display panels 404A, 404B, which are also depicted in FIG. 4B) and may additionally display information or content on a side perpendicular to the main display 406 (e.g., the display screen 405C on a right face of the side lighting display 404B, as depicted in FIG. 4C, and a display screen on aleft face of the side lighting display 404A, not viewable put present). In some examples, the side lighting displays may be placed at an edge along the main display 406 and at an angle to the main display 406. The side lighting display panels 404A, 404B may include a plurality of LED arrays capable of displaying graphics, video, dynamic images, text (dynamic, animated, static, etc.), and/or other multimedia content, as non-limiting examples. Additionally or alternatively, the plurality of LED arrays may transmit light, pixels, and images of varying intensities. The number, shape, and arrangement of LEDs and/or LED arrays within the plurality of LED arrays can further impact the intensities of the transmitted light, pixels, and images, thereby impacting the graphics, the video, dynamic images, text (dynamic, animated, static, etc.) which are displayed on the display screens 405A, 405B, 405C of the side lighting display panels 404A, 404B.

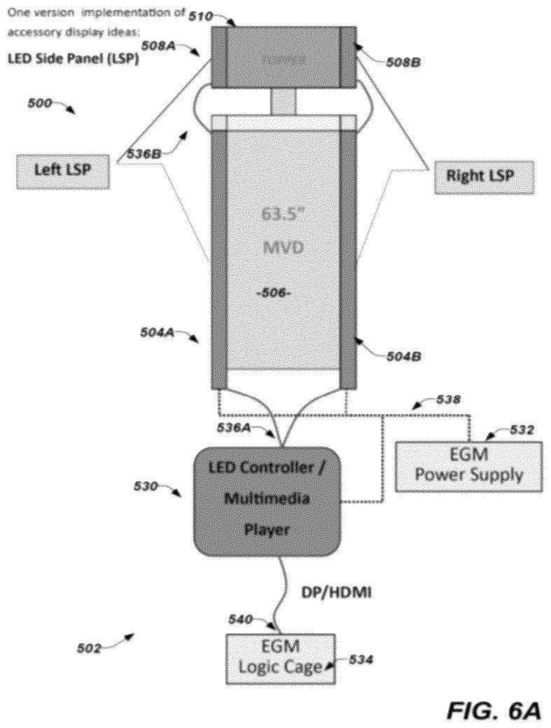

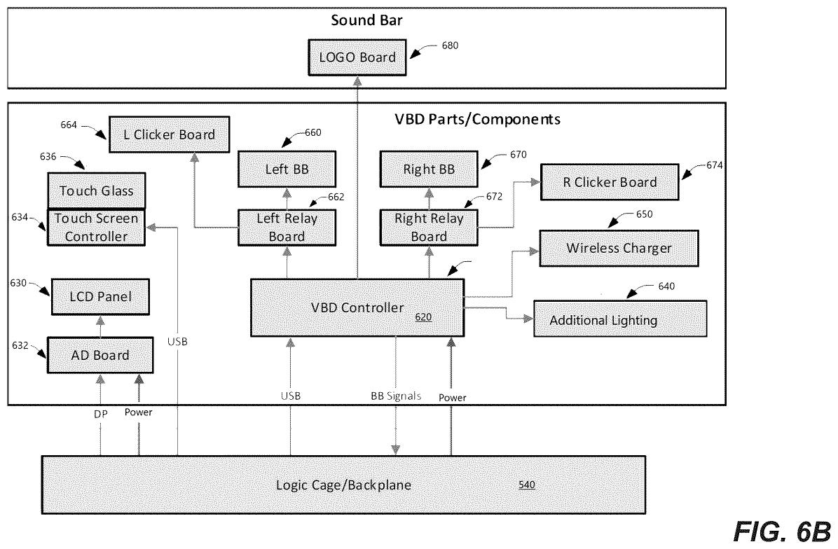

Operation of the main display 406 and one or both of the side lighting display panels 404A, 404B may be coordinated, such that dynamic content flow across or otherwise extends over the display screen 407 and/or any of the display screens 405A, 405B, 405C (and the left facing display screen which is not shown) of side lighting display panels 404A, 404B, which is described in further detail related to FIG. 6A below. The lower most portions of the side lighting display panels 404A, 404B extend past the lower most edge of the main display 406. The side lighting display panels 404A, 404B, may be side-mounted vertical panels of dense LED strips, and may be flush with the screen of main display 406, to create an extended canvas to interact with a player.

In some examples, the gaming machine 400 may include a player money module interface (PMM) 460 operatively connected to the main display 406 and a button deck 420 (e.g., a Virtual Button Deck (VBD) with dual bash buttons and a wireless charger). The button deck 420 may be (i) separated from the main display 406 via PMM 460 and (ii) nested in between lower portions of the side lighting display panels 404A, 404B. In some examples, caps 440A and 440B are directly above and operatively connected to side lighting display panel 404A and side lighting display panel 404B, respectively. In some examples, cap 440A and cap 440B may be integrated candles or endcaps, as non-limiting examples. The gaming machine 400 may include a top appendage 438 which is: (i) in between and operatively connected to the caps 440A and 440B and (ii) directly above and operatively connected to the main display 406. In some examples, the top appendage includes one or more speakers (which may be integrated speakers 442). Additionally or alternatively, speakers may also be located in or around the VBD or at other locations of the gaming cabinet 416.

Although illustrated as being substantially vertically oriented, the side lighting display panels 404A, 404B may be arranged at an angle and/or horizontally relative to the orientation of the main display 406. Moreover, although illustrated as extending beyond the bottom of a length of the main display 406, in some examples the panels may extend beyond a top and bottom, whereas in other examples the panels may frame a smaller portion of the main display 406. In some examples, the panels can frame the main display 406 on all four sides.

Operation of the side lighting display panels 404A, 404B may be controlled via a controller 402, or via an LED controller (which is described in more detail below with regards to FIG. 6A) which may control one or more features displayed on the side lighting display panels 404A and 404B. For example, the features for display may change the character, tone, and/or color of the lighting, as well as provide dynamic graphic content, either concurrently or in succession.

Operation may be coordinated with one or more materials 412 overlaying the light displays, such as a decorative material, a semi-transparent layer like blocking See-Through Panel (STP), including themed content, advertisements, and/or other descriptive material that can be enhanced and/or modified by the light beneath. As a result, a dramatic effect could be presented to the player and/or passersby.

FIGS. 4B and 4C provide front and side views of the gaming machine 400 of FIG. 4A.

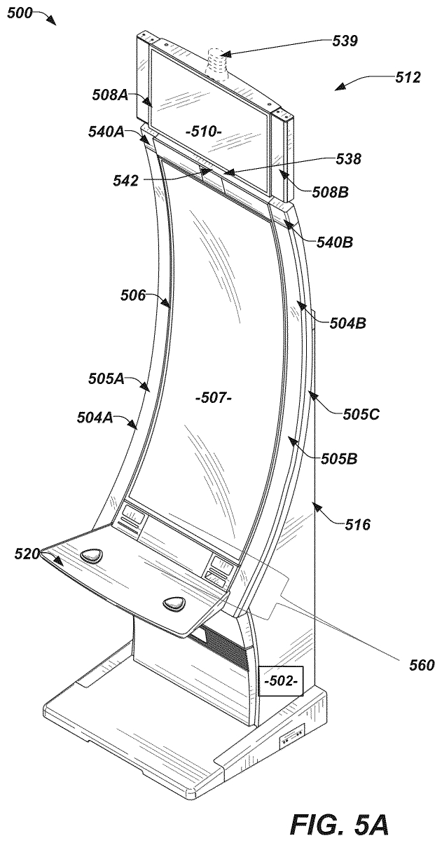

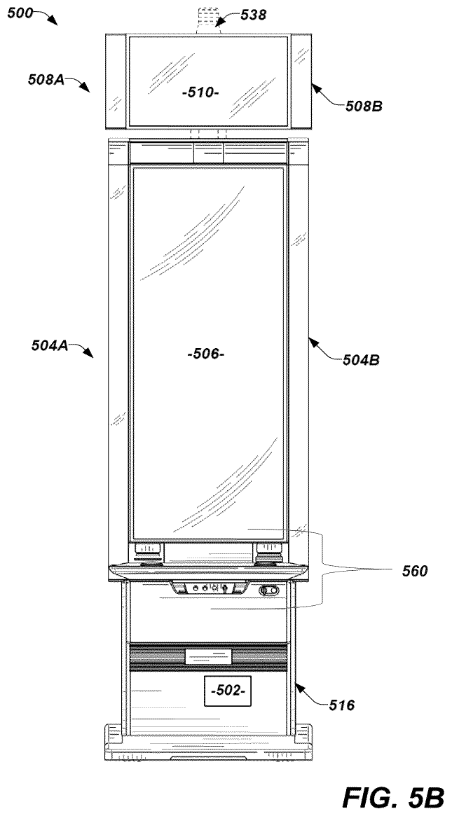

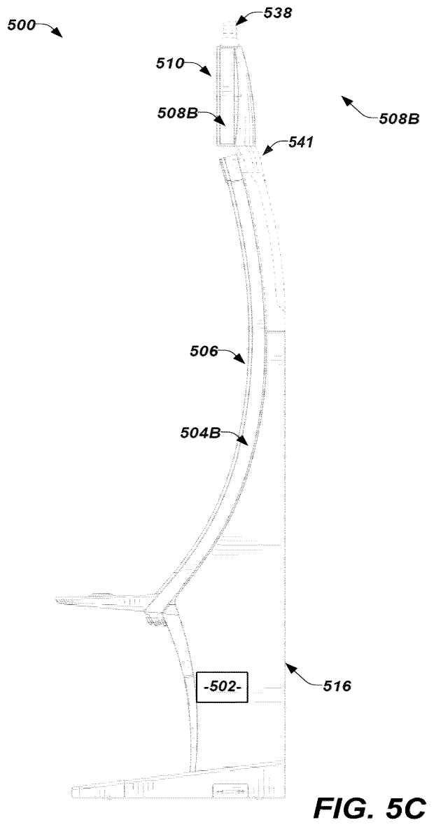

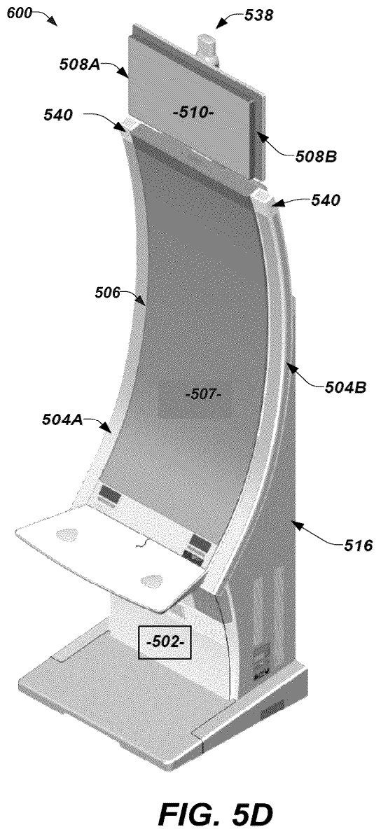

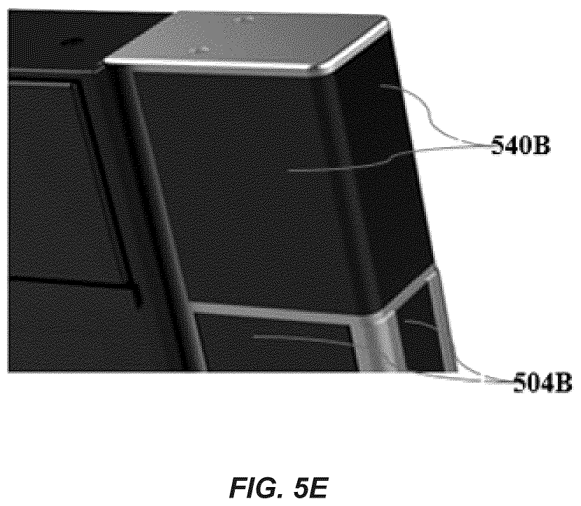

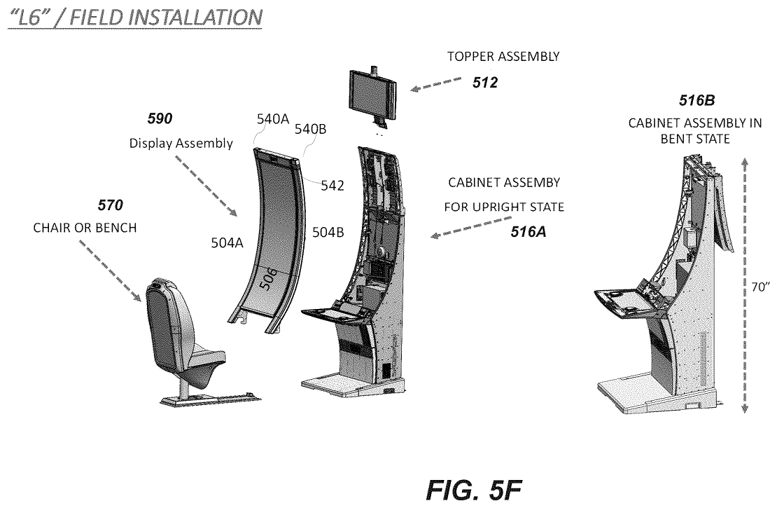

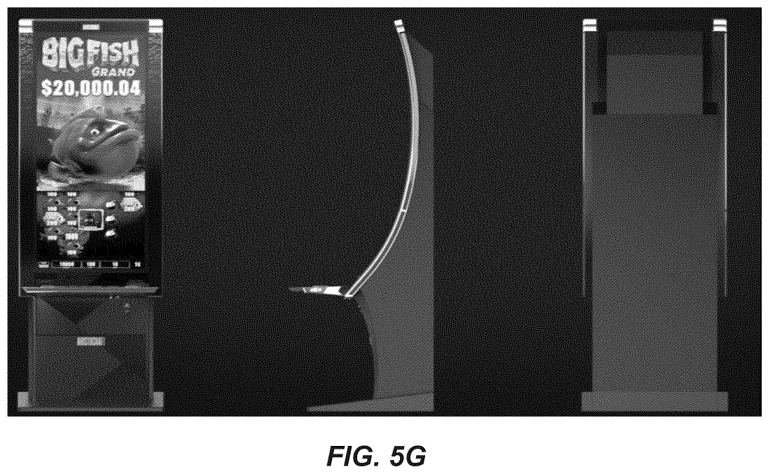

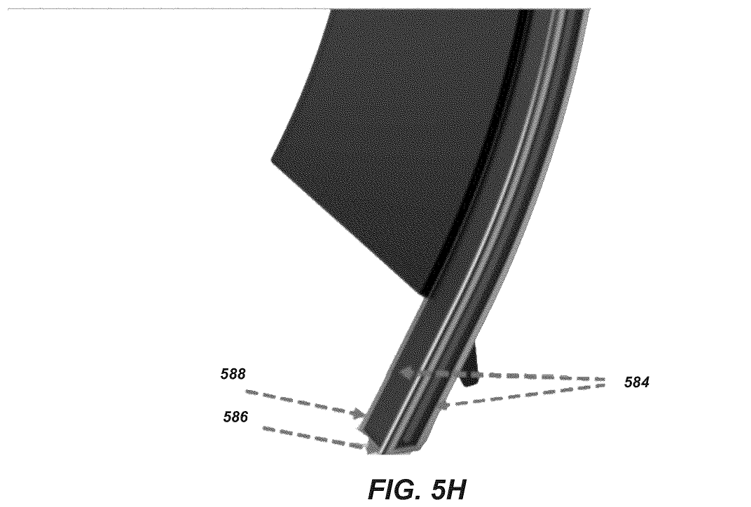

Turning to FIGS. 5A through 5C, a game machine 500, similar to game machine 400 of FIGS. 4A to 4C, includes one or more side lighting displays, such as left-side lighting display panel 504A and right-side lighting display panel 504B. In some examples, the side lighting display panels 504A, 504B are in front of and extending past the left and right most edges of the gaming machine cabinet 516, framing the sides of the main display 506. The main display 506 can be operatively connected to: (i) the gaming machine cabinet 516 as a support for maintaining the main display 506 in an upright position and (ii) a top appendage 538 for further supporting the main display 506, which prevents tipping, such that a bottom edge of the top appendage 538 may be connected to the gaming machine cabinet 516. Additionally, the main display 506 may have a display screen 507 having a curvature identical or substantially similar to curvatures of display screens 505A, 505B, 505C of side lighting display panels 504A, 504B, wherein the display screen 507 of the side lighting display panel 504B has the same curvature of the display screen of the side lighting display panel 504A.

In some examples, the side lighting displays 504A, 504B may display information or content on a same side as the display screen 507 of the main display 506 (e.g., the respective front faces of the side lighting display panels 504A, 504B, which are the display screens 505A, 505B of the side lighting display panels 504A, 504B, as depicted in FIG. 5B) and may additionally display information on a side perpendicular to the main display 506 (e.g., 505C and a left side of the left side lighting display panel 504A (not shown). In some examples, the side lighting displays may be placed at an edge along the main display 506 and at an angle to the main display 506. The side lighting display panels may be comprised of a plurality of LED arrays capable of displaying graphics, video, and/or other multimedia content, as non-limiting examples. More particularly, the plurality of LED arrays can transmit light, pixels, and images of varying intensities. The number, shape, and arrangement of LED arrays within the plurality of LED arrays can further impact the intensities of the transmitted light, pixels, and images, thereby impacting the graphics, the video, dynamic images, text (dynamic, animated, static, etc.) which may be displayed on display screens 505A, 505B, 505C, and/or and the left facing side of side lighting display panel 504A (which is not shown).

As such, the operation of the main display 506 and one or both of the side lighting display panels 504A, 504B may be coordinated, such that dynamic content flow across or otherwise extends over the side lighting display panels 504A, 504B. Other features of the gaming machine 500 include, but are not limiting to, a button deck 520, top appendage 538, one or more caps 540, one or more (integrated) speakers 542, and/or a controller 502. A lower portion of the side lighting display panels 504A, 504B may extend past a lower edge of the main display 506. In some examples, the side lighting display panels 504A, 504B, which may be side-mounted vertical panels of dense LED strips, have front faces flush with the display screen 507 of main display 506, to create an extended canvas for interaction with a player.

Other features of the gaming machine 500 include, but are not limited to: a topper assembly 512 including an accessory display, a candle, and/or a biasing neck 541; a PMM 560 which may be operatively connected to the main display 506 and a button deck 520 (e.g., a Virtual Button Deck (VBD) with dual bash buttons and a wireless charger), wherein the button deck 520 is: (i) separated from the main display 506 via PMM 560 and (ii) nested in between the lower most portions of the side lighting display panels 504A, 504B; caps 540A and 540B directly above and operatively connected to side lighting display panel 504A and side lighting display panel 504B, respectively, wherein the cap 540A and cap 540B may be one or more integrated candles or one or more endcaps; a top appendage 538 which is: (i) in between and operatively connected to caps 540A, 540B (ii) directly above and operatively connected to the main display 506, wherein the top appendage contains one or more speakers (which may be integrated speakers 542); and (iii) in front of and/or a controller 502.

In some examples, a topper assembly 512 is attached to the cabinet 516. The topper assembly 512 may include: an accessory display, biasing neck 541 (as depicted in FIG. 5C) operatively connected to top appendage 538, and a candle (e.g., standard candle 539). The accessory display, such as display 510, may be a flat screen or curved screen that is: (1) sandwiched or framed in between two side lighting display panels, such as side lighting display panels 508A, 508B or (2) mounted against a support surface, such as support 511 (as depicted in FIG. 5D). As depicted in FIGS. 5A-5C, the side lighting display panels 504A, 504B, may be rectangular, and may have a same curvature as display 510, which may also be rectangular. In some examples, the side lighting display panels 540A, 540B, may each be C-curved and may have a same curvature as main display 506, which may also be C-curved. The biasing neck 541 may retain the topper assembly 512 above and spaced from the display 506 comprising the side lighting display panels 504A, 504B framed in between the main display 506, the top appendage 538 with integrated speaker 542, and the caps 540A, 540B. In some examples, the caps 540A and 540B may be mounted directly above the side lighting display panels 504A, 504B as, for example, integrated candles.

In some examples, the standard candle 539 may be a lighting electronic structure that is not identical to the integrated candles. The standard candle 539 may be: (i) operatively connected to and above the accessory display (see FIG. 5A—FIG. 5C) or (ii) operatively connected to and above biasing neck 541, and behind support 511 (see FIG. 5D). The respective integrated candles may be the caps 540A and 540B. If a standard candle 539 is utilized, then the caps 540A and 540B are darkened as depicted in FIG. 5E. If the integrated candle is utilized, then the caps 540A and 540B, which each have four viewable faces, have a dual tiered electronic lighting structure, as depicted in FIG. 5F. The dual tiered electronic structure is: (i) an upper tier of a first color (e.g., white) across three of the faces and a second color (e.g., orange) across the top-most viewable face of the upper tier of the integrated candle; and (ii) a lower tier of a third color (e.g., red) across three of the faces of the lower tier of the integrated candle. The upper tier is distal from the side lighting display panels and the lower tier is adjacent to the side lighting display panels. The first color, the second color, and the third color of the left most integrated candle can be: (i) identical to the first color, the second color, and the third color of the right most integrated candle, respectively, and (ii) controlled by controller 502.

Similar to the description of the side lighting display panels of FIGS. 4A to 4C, the side lighting display panels may be arranged in any orientation, size, position, and/or number relative to the main display 506 and/or the cabinet 516. FIGS. 5B and 5C provide front and side views of the gaming machine 500 of FIG. 5A.

Additionally in FIGS. 5A-5C, one or more accessory (or secondary) displays 510 can be incorporated with the gaming machine 500. As shown, a topper assembly can include: (i) the accessory display 510, which is mounted above the main display 506; and accessory side lighting display panels 508A, 508B. Framing the left and right sides of the accessory display 510 are the side lighting display panels 508A, 508B, respectively. Similar to side lighting display panels 504A, 504B, accessory side lighting display panels 508A, 508B may comprise front facing accessory display sides, a left facing accessory display side, and a right facing accessory display side. In some examples, the front facing accessory display sides, left facing accessory display side, and right facing accessory display side may comprise display screens, LEDs, etc. In some examples, the operation of the side lighting display panels 508A, 508B, can be coordinated with: (i) the main display 506 and/or the side lighting display panels 504A, 504B; (ii) accessory display 510 and/or the side lighting panels 508A, 508B; and (iii) integrated candles (e.g., caps 540A, 540B in FIG. 5F) and/or standard candles (e.g., standard candle 539 in FIGS. 5A-5C). In some examples, the side lighting display panels 508A, 508B are operated independently. The accessory (or secondary) displays may be controlled by the controller 502 or by an additional controller (not shown). The display of content on the accessory (or secondary) displays 510 and side lighting display panels 508A, 508B of the topper assembly may be coordinated with the respective contents of the side lighting panel displays 504A, 504B, 508A, 508B, the screen of main (or primary) main display 506, and/or VBD 520, wherein the VBD 520 can have an integrated display therein. When display of content is coordinated, a variety of animations may be provided, and/or a larger image presented by utilizing the main display screen 506 with one or more side lighting panel displays 504A, 504B, 508A, and/or 508B, to indicate an event during gameplay.

FIG. 5D provides a views of a gaming machine 600, similar to the gaming machine of FIGS. 5A-5C. The gaming machine 600 includes: topper assembly comprising accessory display 510 in front of and operatively connected to support 511; the biasing neck 541 behind and operatively connected to the support 511; and candle 539 above and operatively connected to the biasing neck 541. The edges of accessory display 510 and/or support 511 may be comprised of a plurality of LED arrays that are capable of displaying graphics, video, and/or other multimedia content, as non-limiting examples. As such, operation of the main display 506 and one or both of the side lighting display panels 504A, 504B may be coordinated, such that dynamic content flow across or otherwise extends over the side lighting display panels 504A, 504B, in combination with the lighting and other contents of caps 540A, 540B as integrated candles, accessory display 510, virtual button deck 520 in an illuminated state, and/or candle 539.

FIG. 5F is an example installation of an electronic gaming machine, similar or identical to those in FIGS. 4A-4C and 5A-5E, is depicted. In some examples, a chair or bench 570 and topper assembly 512, as described above, such as the version in FIGS. 5A-5C or FIG. 5D, can be optionally added to the electronic gaming machine. For shipping purposes, the top appendage 538 is bent down towards cabinet 516 (e.g., the bent state 516B). For assembling purposes, the top appendage 538 is upright in relation to cabinet 516 (e.g., the upright state 516A). The virtual button deck, which may include an integrated display therein and two trilobe bash buttons, can be slidably moved akin to a drawer moving along a track. In some examples, the display assembly may comprise: main display 506 composed of two portions; side lighting display panels 504A, 504B composed of three portions which are framed along the left and right side of the main display 506; caps 540A and 540B as integrated candles above and operatively connected to the side lighting display panels 504A, 504B, and top appendage 538 above and operatively connected to the main display 506. Display assembly 590 is attached to the cabinet assembly in the upright state 516A to yield the electronic gaming machine.

In some examples, side panel displays 504A, 504B are each composed of three portions, e.g., a lower portion of each side lighting display panel 504A or 504B, as described above; a center portion which may be flush with the bottom portion of main display 506; and a top portion which may be flush with the top portion of main display 506. In some examples, the lower portion, center portion, and top portion are combined to form: a seamless screen display on a front face and a seamless continuous LED matrix display on the right face of side panel main display 504B (see FIG. 5H); and a seamless screen display on the front face and a seamless, continuous LED matrix display (e.g., lighting display) and/or screen display on the left face of side panel main display 504B. The edges of side lighting display panels 504A and 504B can be framed with a machine aluminum cap 586 (see FIG. 5H) with a silver anode finish 588. A lowermost portion of the side lighting display panels 504A, 504B may each have a hook for being operatively connected at the inner cavity of the cabinet 516. A lower portion of main display 506, which may occupy substantially less viewing area than an upper portion of main display 506, can connect to the upper portion of main display 506 to form a seamless screen display on the front face of main display 506. The ends of the segment in, for example, the (i) seamless screen displays; and (ii) seamless, continuous LED matrix display, correspond to display junctions absent of protruding or inwardly indented surfaces.

In one or more embodiments, along with the hooks described above, the brackets (which are not depicted) in the side display panels 504A and 504B may be modularized (i.e., bottom, center, and top portions) to support facile assembly and disassembly of the display assembly 590. More particularly, the brackets can be mounted on the side display panels 504A and 504B for modular attachment and detachment from the main display 506. More particularly, the bottom, center, and top portions of the side display panels 504A and 504B are modularized, i.e., segmented, such that the portions of the side display panels 504A and 504B can be attached and detached from other portions of the side display panels 504A and 504B. By modularizing the display panels 504A and 504B from the main display 506 and within the display panels 504A and 504B themselves, maintenance and support staff can service the overall display assembly more efficiently and an expedited manner in the field rather than sending the entire display assembly back to the manufacturer for servicing. More particularly, the entirety of the display assembly 590 or entirety of the side display panels 504A, 504B and/or main display 506, does not have to be disassembled during servicing. The end caps 540A and 540B, which can be integrated candle or blacked out, and the sound bar may also be modularized in the display assembly 590 to support facile assembly and disassembly of the display assembly 590.

In some examples, the main display 506, the side lighting display panel 504A, and the side panel 504B are each distinct display units which can be controlled and managed by, for example, controller 502 and/or LED controller (described below with reference to FIG. 6A, for example). Each of the distinct display units can present respective dynamic graphics or multimedia content, which can be similar or different from each other. For example, the respective dynamic graphics or multimedia content presented by the main display 506, the side lighting display panel 504A, and the side panel 504B form a visual output. In the front face of main display 506, e.g., the screen of main display 506, there can be a first graphical output within the larger, upper portion of the main display 506 and a second graphical output within the smaller, lower portion of the main display 506 (see left most image of FIG. 5G). In the front faces of the side lighting display panels 504A and 504B (see the left most image of FIG. 5G), e.g., screens of side lighting display panels 504A and 504B, there is a third graphical output within the lowest, middle, and top portions of the side lighting display panel 504A and fourth graphical output within the lowest, middle, and top portions of the side lighting display panel 504B. In the left face of the side lighting display panel 504A and the right face of the side lighting display panel 504B (see the middle image of FIG. 5G and FIG. 5F), e.g., LED lighting displays, there is a fifth graphical output within the lowest, middle, and top portions of the side lighting display panel 504A and a sixth graphical output within the lowest, middle, and top portions of the side lighting display panel 504B. The lighting, while emanating from the side faces of the side lighting display panels 504A and 504B, can be viewable from the rear of the electronic gaming machine (see right most image of FIG. 5G).

The first and second sets of graphics yield a first set of dynamic graphics or multimedia content, as presented on the screen of the main display 506; the third and fifth set of graphics yield a second set of dynamic graphics or multimedia content, as presented on the screen and side of side lighting display panel 504A; and fourth and sixth set of graphics yield a third set of dynamic graphics or multimedia content, as presented on the screen and side of side lighting display panel 504B. The first set, second set, and third set of dynamic graphics or multimedia content form the visual output that is viewable to the player and other individuals in viewing proximity of the gaming machine. Additionally, the integrated candle and topper assembly 512 can be controlled, in combination with main display 506 and side lighting display panels 504A, 504B, to enhance the visual output, via lighting effects and image displays.

Turning to FIG. 6A, a game machine 500 is operably connected to controller 502. As shown, the controller 502 may be operably connected with one or more of an LED controller or multimedia player 530 and/or an electronic gaming machine logic cage 534. For example, the controller 502 may include one or more of the components described with respect to game controller 202 (e.g., the EGM logic cage 534), disclosed with respect to FIG. 2A, with the added circuitry associated with controller 530. Thus, EGM logic cage 534 may connect to controller 530 via one or more cables 540, through which coordinating instructions can be shared.

The game machine 500 includes a main display 506 and an optional accessory (or secondary) display 510. In some examples, the main display 506 is a multi-modal display configured to display high graphic, high visual impact games in a multivisual mode and legacy games in a legacy mode. The main display 506 may automatically detect the mode based on a signal being received from the controller 502 and/or LED controller 530.

Although several examples illustrate the controller 502 as being housed within gaming cabinet 516, in some examples one or more components logically connected to or incorporated with the controller 502 may be physically and/or logically separate and/or remote, while maintaining the disclosed functionality. Further, although FIG. 6A is described with respect to game machine 500, the operation and/or arrangement of the various components and associated features is applicable to at least the game machine 400 as well.

As shown, the side lighting display panels can be connected to the LED controller 530 via one or more cables 536A, 536B (e.g., via a video port interface), which may transfer power and/or data between the side lighting display panels and the LED controller 530, the logic cage 534, and/or the power supply 532. In some examples, the power supply 532 provides power to the side lighting display panels directly via cables 537.

In some examples, operation of the side lighting display panels 504A, 504B, 508A, 508B (e.g., content or color selection, pace of changes, etc.) is driven by gameplay (e.g., a player selection, a game outcome, etc.). Thus, the LED controller 530 can be physically and/or logically connected to the EGM logic cage 534 to coordinate and/or take instruction from the EGM logic cage 534. In some examples, operation of the side lighting display panels 504A, 504B, 508A, 508B, is independent of gameplay, such as to attract a passerby or provide non-game related information, as a list of non-limiting examples. Control for such an operation can be stored within the LED controller 530. In some examples, the operation of side lighting display panels 504A, 504B, 508A, 508B may be controlled by a remote device, such as a server 284a, remote user 274c, 274a, 274b as described above with regards to FIG. 2D, or by a nearby mobile device (not shown).

In some examples, the LED controller 530 converts content, such as multimedia signals, images, video, etc. to a form that is displayable on the main display 506, side lighting display panels 504A, 504B, 508A, 508B, and/or on the secondary display 510. The LED controller 530 may control pixel level brightness and chroma calibration at each LED individually, which can effectively remove brightness differences and chroma differences and greatly improve display brightness consistency and chroma consistency, allowing for better image quality, quick adjustment of dark or bright lines. Additionally, the LED controller 530 may provide individual gamma adjustment for Red, Green, and Blue (RGB) display. The side lighting display panels 504A, 504B, 508A, 508B, have the ability to display complex, progressive graphics that are coordinated with the main display 506, and/or the secondary display 510. Each of the main display 506 and/or the secondary display 510 may comprise a separate controller (not shown), and the LED controller 530 may coordinate the display of content with the separate controllers of each of the main display 506 and/or the secondary display 510.

Turning to FIG. 6B, a game machine 500 may be operably connected to a virtual button deck 610. As depicted in FIG. 6B, the logic cage 540 connects to a VBD controller 620 that controls the various components of the VBD 610. The VBD controller 620 may be located inside the gaming cabinet, near the logic cage 540, external to the cabinet, as non-limiting examples. The VBD 610 may be connected to an LCD panel 630, an analog/digital (AD) board 632, a touch screen controller 634, touch glass 636, additional lighting 640, a wireless charger 650, a left bash button 660, a right bash button 670, a left relay board 662, a right relay board 672, a left clicker board 664, and a right clicker board 674. The VBD controller 620 may additionally output sound and/or information to a sound bar 680.

The LCD panel 630 may include individually controllable and fully game controllable multicolor/RGB LEDs to produce a broad array of colors. The VBD controller 620 may control lighting aspects of the VBD 610. For example, the VBD 610 may control additional lighting 640 to provide a halo or other lighting effects surrounding the left bash button 660 and/or the right bash button 670, as well as lighting on other portions of the gaming cabinet, such as the logos on the top, front, sides or back of the gaming cabinet as non-limiting examples. The additional lighting may be single color lighting such as white, red, blue, green, etc. or may include a variety of colors and/or effects (such as pulsing, blinking, etc.) The touchscreen controller 634 may receive input from the touch glass 636, as well as activate certain aspects or portions of the touch glass 636 to accept input. The VBD controller 620 may also control the wireless charger 650. The wireless charger 650 may be located on or near the VBD, or on a top, back, front, bottom, or side surface of the gaming cabinet, or near the gaming cabinet. The wireless charger 650 may provide an indication (e.g., visual, auditory, etc.) that may be displayed on the VBD 610, on the main display 506, or on the side lighting display panels 504A, 504B, 508A, 508B, etc. that a device (for example, a mobile device, smartwatch, etc.) is being charged by the wireless charger 650 or that the device is fully charged. The wireless charger may detect foreign objects located in or near a wireless charging area provided by the wireless charger and inform user via a visual or auditory indication as described above. Additionally, the wireless charger 650 may provide a locking mechanism to secure the device being charged and may provide an indication if the device is removed or otherwise tampered with.

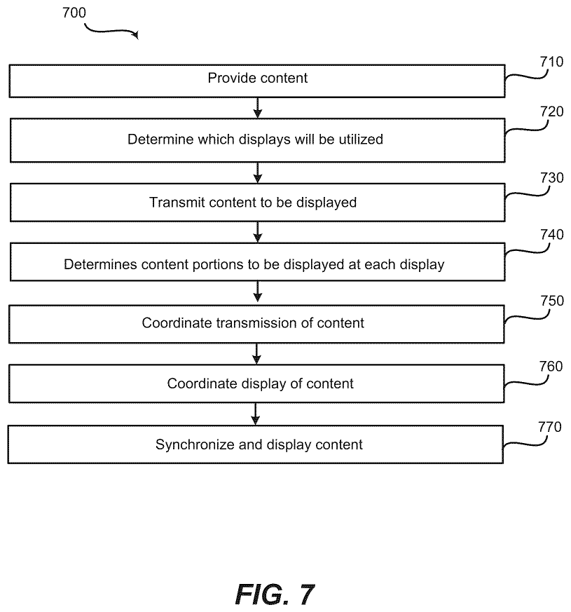

Referring to FIG. 7, a flowchart illustrates exemplary steps for operating an electronic gaming system in accordance with various implementations described herein. In some examples, the method 700 begins by providing content to the controller 502 and/or logic cage 534 of the EGM (e.g., multimedia images, text, and/or video) 710. The content may be provided remotely from a server or may be provided from a memory or other local storage at the EGM.

At step 720, the controller 502 and/or logic cage 534 determines which displays may be utilized for the content provided based on the characteristics of the base game or feature game being played, based on the characteristics of the content, and/or based on the characteristics of the display. Characteristics of the dynamic graphics or multimedia content may be, for example, a format type of the graphics or multimedia content (e.g., mpg, avi, mp3, wmv, flash, gif, mov, tiff, motion jpeg, etc.), a minimum resolution for display, a minimum display size, or a message type (e.g., text, graphics, etc.). Example characteristics of the main display, secondary display, and the plurality of side panel displays includes at least one of a position, a size, or a resolution of the main display, the secondary display, and the side lighting display panels. For example, in some instances, the controller 502 and/or logic cage 534 may determine that the content should be displayed on a main display 506 and/or a secondary display 510, or that the content should be displayed on one of the side lighting display panels 504A, 504B, 508A, 508B. The controller 502 may select any of the main display 506, the secondary display 510, and/or the side lighting display panels 504A, 504B, 508A, 508B.

At step 730, the controller 502 or logic cage 534 transmits the content to be displayed to the LED controller 530 and may transmit any additional content (such as sound, for example) to another appropriate destination (e.g., to sound bar). At step 740, the LED controller 530 determines which portions of the content will be transmitted to each of the displays (e.g., main display 506, the secondary display 510, and/or the side lighting display panels 504A, 504B, 508A, 508B). In some examples, the LED controller 530 determines that a portion of the content should be displayed on the left side lighting display panel 504A, a second portion should be displayed on the main display, and a third portion should be displayed at the right-side lighting display panel 504B. In some examples, the LED controller 530 may select individual LEDs of any of the main display, the secondary display, and/or the side lighting display panels 504A, 504B, 508A, 508B to display the content.

At step 750, the controller 502 and LED controller 530 coordinate the transmission of the content portion(s) to the main display, the secondary display, and the virtual button deck, as well as the activation of touch inputs at the VBD based on the content provided. For example, the LED controller 530 may send a portion of the content to be transmitted to the main display, a second portion of the content to be displayed to the secondary display, and a third portion of the content to the LED controller 530 to control the display on the left side lighting display panel and the right side lighting display panel, while the controller 502 coordinates with the VBD and/or the VBD controller 620 to activate touch inputs and/or lighting effects at the VBD, as well as to output sound at the sound bar 680. In some examples, the controller 502 may send portions of the content to each of the main display 506, the secondary display 510, and the side lighting display panels 504A, 504B, 508A, 508B directly.

At step 760, the controller 502 may coordinate with the LED controller 530 and the VBD controller to display the content across the main display, secondary display, and/or side lighting display panels (e.g., the first, second, third, fourth, fifth, and sixth set of graphics, as described above). Additionally, the VBD controller 620 may simultaneously coordinate the display of content and touch input controls with the VBD touchscreen controller.

At step 770, the content is synchronized and displayed across the main display, the secondary display, the side lighting panels, and/or the VBD, thereby leading to a visual output derived from, for example, the first set, second set, and third set of dynamic graphics or multimedia content, as described above. More particularly, the first set of dynamic graphics or multimedia content, as presented on main display 506, can be synchronized with: (i) the second set of dynamic graphics or multimedia content, as presented on side lighting display panel 504A; and (ii) the third set of dynamic graphics or multimedia content, as presented on side lighting display panel 504B.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a main display comprising a main screen with a first curvature and operable for displaying a first set of dynamic graphics or multimedia content;
a plurality of side display panels arranged vertically adjacent to the main display, wherein each side display panel of the plurality of side display panels comprises a screen with a second curvature and is operable to display: (i) a second set of dynamic graphics or multimedia content, (ii) a third set of dynamic graphics or multimedia content, or (iii) the second set of dynamic graphics or multimedia content and the third set of dynamic graphics or multimedia content; and
a game controller comprising a processor and memory storing program code including instructions, the game controller executing the instructions which cause the game controller to:
control display of the first set of dynamic graphics or multimedia content on the main display; and
coordinate display of the first set of dynamic graphics or multimedia content on the main display with (i) the second set of dynamic graphics or multimedia content, (ii) the third set of dynamic graphics or multimedia content, or (iii) the second set of dynamic graphics or multimedia content and the third set of dynamic graphics or multimedia content on the plurality of side display panels as a visual output,
wherein the first curvature is identical to the second curvature.

2. The electronic gaming system as claimed in claim 1, wherein the visual output is the first set of dynamic graphics or multimedia content synchronized with the (i) the second set of dynamic graphics or multimedia content, (ii) the third set of dynamic graphics or multimedia contents, or (iii) the second set of dynamic graphics or multimedia content and the third set of dynamic graphics or multimedia content.

3. The electronic gaming system as claimed in claim 1, further comprising an accessory display framed by one or more accessory side display panels, wherein the game controller is further operable to execute instructions which cause the game controller to control display of the visual output on the one or more accessory side display panels.

4. The electronic gaming system as claimed in claim 1, further comprising an integrated candle.

5. The electronic gaming system of claim 1, further comprising a light emitting diode (LED) controller configured to synchronize the visual output with the game controller.

6. The electronic gaming system of claim 5, wherein the LED controller is configured to convert the first set of dynamic graphics or multimedia content, the second set of dynamic graphics or multimedia content, the third set of dynamic graphics or multimedia contents, or the second set of dynamic graphics or multimedia content and the third set of dynamic graphics or multimedia content to a form that is displayable on the main display and the plurality of side display panels.

7. The electronic gaming system of claim 6, wherein the LED controller is further configured to individually control LEDs on the main display and the plurality of side display panels.

8. An electronic gaming machine comprising:
a curved main display;
a plurality of side display panels adjacent to the curved main display;
a light emitting diode (LED) controller; and
a gaming controller configured to control the LED controller to coordinate a display of multimedia content across the curved main display and the plurality of side display panels based on one or more characteristics of the multimedia content and one or more characteristics of the curved main display and the plurality of side panel displays.

9. The electronic gaming machine of claim 8, further comprising a virtual button deck (VBD) and a VBD controller, wherein the gaming controller is further configured to control the VBD controller and the LED controller to synchronize an activation of touch inputs via the virtual button deck with the display of multimedia content across the curved main display and the plurality of side display panels.

10. The electronic gaming machine of claim 9, wherein the gaming controller is further configured to control the VBD controller to synchronize output sound to a sound bar with the activation of touch inputs via the virtual button deck and the display of multimedia content across the curved main display and the plurality of side display panels.

11. The electronic gaming machine of claim 10, wherein the gaming controller is further configured to control the VBD controller and the LED controller to synchronize an activation of touch inputs via the VBD with the display of multimedia content across the curved main display and the plurality of side display panels.

12. The electronic gaming machine of claim 8, further comprising an accessory display and a plurality of accessory side display panels.

13. The electronic gaming machine of claim 8, wherein the plurality of side display panels comprise a set of LEDs adjacent to the curved main display and a second set of LEDs perpendicular to the curved main display.

14. A method of operating an electronic gaming device comprising:
providing dynamic graphics or multimedia content to a controller;
determining one or more displays from a main display and one or more side lighting displays to present the dynamic graphics or multimedia content;
transmitting the dynamic graphics or multimedia content to a light emitting diode (LED) controller; and
controlling synchronization of a presentation of the dynamic graphics or the multimedia content across the one or more displays by displaying a first portion of the dynamic graphics or multimedia content on the main display and displaying a second portion of the dynamic graphics or multimedia content on the one or more side lighting displays.

15. The method of claim 14, further comprising coordinating the presentation of the dynamic graphics or multimedia content with an activation of touch inputs at a virtual button deck (VBD).

16. The method of claim 14, further comprising determining to control the main display or the one or more side lighting displays based on one or more characteristics of the dynamic graphics or multimedia content and one or more characteristics of the main display and the one or more side lighting displays.

17. The method of claim 16, wherein the one or more characteristics of the dynamic graphics or multimedia content includes at least one of a format type, a minimum resolution, a minimum display size, or a message type.

18. The method of claim 17, wherein the one or more characteristics of the main display and the one or more side lighting displays includes at least one of a position, a size, or a resolution of the main display and the one or more side lighting displays.

19. The method of claim 14, further comprising coordinating the presentation of the dynamic graphics or multimedia content with sound at a sound bar.

20. The method of claim 14, further comprising coordinating the presentation of the dynamic graphics or multimedia content with an accessory display.
